(19) United States
(12) Patent Application Publication
(10) Pub. No.: US 2015/0066374 A1
(43) Pub. Date: Mar. 5, 2015

(54) SEISMIC DATA PROCESSING WITH FREQUENCY DIVERSE DE-ALIASING FILTERING

(71) Applicant: WESTERNGECO L.L.C., HOUSTON, TX (US)

(72) Inventors: Ying Ji, Katy, TX (US); Julian Edward Kragh, Great Bardfield (GB); Philip A. F. Christie, Fen Drayton (GB)

(21) Appl. No.: 14/385,731

(22) PCT Filed: Apr. 3, 2013
(86) PCT No.: PCT/IB2013/052663

§ 371 Date: Sep. 16, 2014

Related U.S. Application Data
(60) Provisional application No. 61/619,999, filed on Apr. 4, 2012.
(60) Provisional application No. 61/643,087, filed on May 4, 2012.

(51) Int. Cl. G01V 1/36; G01V 1/24

(52) U.S. Cl. CPC G01V 1/362; G01V 1/247
USPC 702/17

(57) ABSTRACT

Performing seismic data processing using frequency diverse basis functions and converting a data processing problem into a one-norm or zero-norm optimization problem, which can be solved in frequency-space domain. The data processing problems can be data deghosting, data regularization or interpolation. The data being processed can be aliased or un-aliased, single sensor data or group-formed data, single component or multi-component data single source data or simultaneous sources, or some combinations.

### CROSS-REFERENCE TO RELATED APPLICATIONS

This application claims the benefit of U.S. Provisional Application Ser. No. 61/619,999 filed on Apr. 4, 2012, and U.S. Provisional Application Ser. No. 61/643,087 filed on May 4, 2012, the disclosures of which are incorporated by reference herein in their entirety for all purposes.

### BACKGROUND

This disclosure relates to seismic exploration for oil and gas and, in particular but not by way of limitation, to seismic data processing using frequency diverse de-aliasing filtering.

Seismic exploration involves surveying subterranean geological formations for hydrocarbon deposits. A survey may involve deploying seismic source(s) and seismic sensors at predetermined locations. The sources generate seismic waves, which propagate into the geological formations, creating pressure changes and vibrations along the way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), while others are sensitive to particle motion (e.g., geophones); industrial surveys may deploy one type of sensor or both types. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may not only be conducted in saltwater environments, but also in fresh and brackish waters. In one type of marine survey, called a “towed-array” survey, an array of seismic sensor-containing streamers and sources is towed behind a survey vessel. Other surveys are known as “land” surveys because they are conducted on land environments. Land surveys may use dynamite or seismic vibrators as sources. Arrays of seismic sensor-containing cables are laid on the ground to receive seismic signals. The seismic signals may be converted, digitized, stored or transmitted by sensors to data storage and/or processing facilities nearby, e.g. a recording truck. Land surveys may also use wireless receivers to avoid the limitations of cables. Seismic surveys may be conducted in areas between land and sea, which is referred to as the “transition zone”. Other surveys, incorporating both hydrophones and geophones, may be conducted on the seabed.

One of the goals of the seismic survey is to build up an image of a survey area for purposes of identifying subterranean geological formations. Subsequent analysis of the representation may reveal probable locations of hydrocarbon deposits in subterranean geological formations. However, before a desired image can be built, the acquired seismic data need to be processed, e.g. cleaned and re-conditioned. The desired signals are the ones that travel from a source, are reflected by a subsurface structure once and are received by a receiver. They are referred to as direct reflection signals. The direct reflection signals are used to build up an image. All other undesired signals or noises need to be removed from the acquired seismic data. Some of the undesired signals that are reflected by subsurface structures multiple times before reaching a receiver are referred to as “multiples”. Others that are reflected by air-water interface (ocean surface) at least once are referred to as “ghost” signals. Signals originating from sources other than the controlled seismic sources of the survey are noises. There are many different methods to process seismic data to obtain the desired seismic data.

Many imaging processes need input data to be sampled at certain regular intervals and certain sampling density (i.e. un-aliased data). The data acquired from many seismic surveys may not meet such requirements, so re-conditioning is needed. For example, the acquired data may need to be interpolated from the actual sampling density (spatial or temporal) to a more densely and regularly spaced sampling grid; this process may be referred to as regularization and/or interpolation.

To acquire seismic data more efficiently and with less cost, an acquisition method called “simultaneous source” method has been used in recent years. In a non-simultaneous sources marine survey, a delay is introduced between the firing of one seismic source and the firing of the next seismic source, and the delay is sufficient to permit the energy that is created by the firing of one seismic source to decay to an acceptable level before the energy that is associated with the next seismic source firing arrives. The use of such delays, however, imposes constraints on the rate at which the seismic data may be acquired. For a towed marine survey, these delays also imply a minimum inline shot interval because the minimum speed of the survey vessel is a constraint as well as the time necessary to re-charge the firing compressors.

In a “simultaneous source” survey, simultaneously-fired or near-simultaneously-fired seismic sources are used (the delay described above is reduced to a small fraction of its length), in which signals from the sources interfere for at least part of each record. This “simultaneous source” survey has benefits in terms of acquisition efficiency and (typically inline) source sampling. However, for this technique to be useful, the acquired seismic data need be separated into the datasets that are each uniquely associated with one of the seismic sources.

There are many ways to separate acquired composite data into datasets that are uniquely associated with one of the seismic sources, for example, as disclosed in a pending U.S. patent application Ser. No. 11/964,402, ('402 application) (Attorney docket number 57.0820), filed on Dec. 26, 2007 by Ian Moore et al., titled “Separating seismic signals produced by interfering seismic sources”; U.S. patent application Ser. No. 12/256,135, (Attorney docket number 53.0100) filed on Oct. 22, 2008 by Ian Moore, titled “Removing seismic interference using simultaneous or near simultaneous source separation”; U.S. patent application Ser. No. 12/429,328, (Attorney docket number 53.0112) filed on Apr. 24, 2009 by Ian Moore et al., titled “Separating seismic signals produced by interfering seismic sources”; U.S. patent application Ser. No. 13/305,234, ('234 application, Attorney docket number IS11.0742) filed on Nov. 28, 2011 by Ying Ji et al., titled “Separation of simultaneous source data.” All of the above patent applications are assigned to the same assignee as the current application. All of the above patent applications are hereby incorporated by reference.

It is desirable to find a method that can process seismic data more efficiently.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

This disclosure relates to methods and apparatuses for processing seismic data using frequency diverse de-aliasing filtering. The methods may work with aliased or un-aliased data, single-sensor data or group-formed data, single component data or multi-component data, 2D or 3D seismic survey data. The methods use the combination of array responses or steering vectors at different frequencies to suppress the spatial aliasing and convert the data processing/separation problem into a one-norm (I₁) or zero-norm (I₀) optimization problem. A slowness-time model is obtained from the optimization problem. Based on the data processing purposes, customized basis functions are constructed. Using the same slowness-time model, the desired data can be calculated using appropriate basis functions.

For deghosting, two sets of basis functions are constructed, one with the ghost and the other without the ghost. The data may be acquired by flat streamers, slant streamers or over/under multiple depth streamers.

For data interpolation/regularization, a set of basis functions with the known data receiver locations and another set of basis functions with the desired regularized and densely-spaced data receiver locations are constructed.

### BRIEF DESCRIPTION OF DRAWINGS

Embodiments of this disclosure are described with reference to the following figures. The same numbers are used throughout the figures to reference like features and components. A better understanding of the methods or apparatuses can be had when the following detailed description of the several embodiments is considered in conjunction with the following drawings, in which:

FIG. 1 illustrates a seismic acquisition system in a marine environment;

FIG. 2 illustrates a flow diagram of an example method using a frequency diverse de-aliasing filter, in accordance with an embodiment of the present invention;

FIGS. 3a-3c illustrate examples of synthetic data with ghosts, the de-ghosted data, and the error in a space-time domain, an associated wavenumber-frequency domain and space-frequency, where the streamer is a flat streamer;

FIGS. 4a-4c illustrate examples similar to the examples in FIG. 3, except that the illustrated data comprises aliased data;

FIGS. 5a-5c illustrates examples similar to the examples in FIG. 3, except that the illustrated data comprises data acquired by a slant streamer;

FIGS. 6a-6c illustrates examples similar to the examples in FIG. 5, except that the illustrated data is aliased;

FIG. 7 illustrates an example of true data used to test an interpolation method shown in space-time domain and wavenumber-frequency domain;

FIG. 8 illustrates an example of synthetic aliased data to be interpolated or regularized;

FIG. 9 illustrates interpolated data based on the data shown in FIG. 8;

FIG. 10 illustrates errors between the interpolated data shown in FIG. 9 and the original data shown in FIG. 7; and

FIG. 11 illustrates a schematic view of a computer system on which some of the methods disclosed herein may be implemented.

### DETAILED DESCRIPTION

Reference will now be made in detail to embodiments, examples of which are illustrated in the accompanying drawings and figures. In the following detailed description, numerous specific details are set forth in order to provide a thorough understanding of the subject matter herein. However, it will be apparent to one of ordinary skill in the art that the subject matter may be practiced without these specific details. In other instances, well-known methods, procedures, components, and systems have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step. The first object or step, and the second object or step, are both objects or steps, respectively, but they are not to be considered the same object or step.

The terminology used in the description of the disclosure herein is for the purpose of describing particular embodiments only and is not intended to be limiting of the subject matter. As used in this description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

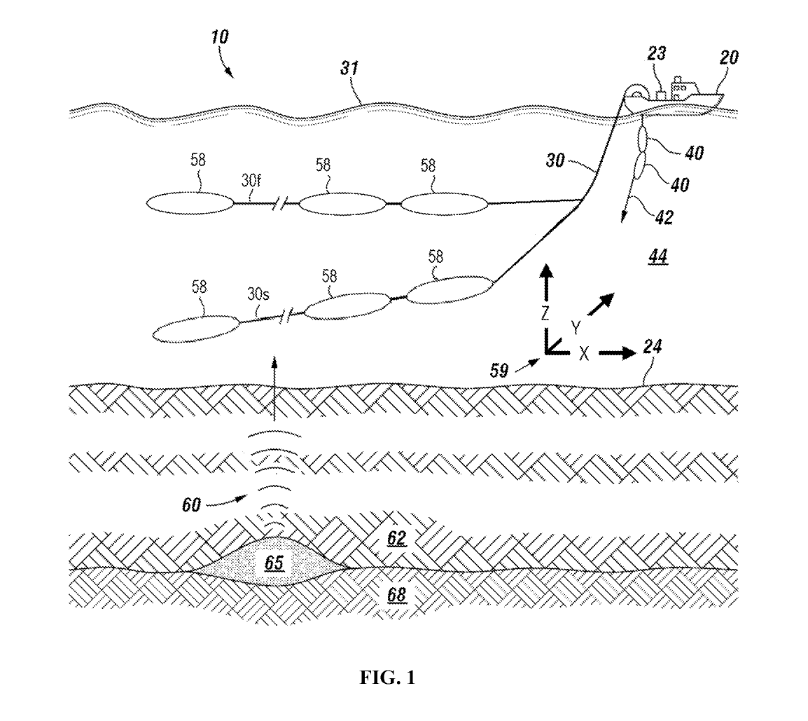

FIG. 1 depicts an embodiment 10 of a marine-based seismic data acquisition system. In the system 10, a survey vessel 20 tows one or more seismic streamers 30 (one streamer 30 being depicted in FIG. 1) behind the vessel 20. It is noted that the streamers 30 may be arranged in a spread in which multiple streamers 30 are towed in approximately the same plane at the same depth, for example, a flat streamer 30f as shown in FIG. 1. As another non-limiting example, a streamer may be towed in a slant plane such that the sensor depth is varied depending on its inline offset, such as a slant streamer 30s shown in FIG. 1. In another example, multiple streamers may be towed at multiple depths, such as in an over/under spread (not shown in FIG. 1), in which an over-streamer is on top of an under-streamer and the two streamers are the same except deployed at the different depths.

The seismic streamers 30 may be several thousand meters long and may contain various support cables (not shown), as well as wiring and/or circuitry (not shown) that may be used to support communication along the streamers 30. In general, each streamer 30 includes a primary cable which is coupled with seismic sensors that record seismic signals. The streamers 30 contain seismic sensors 58, which may be hydrophones to acquire pressure data, multi-component sensors and/or the like. For example, sensors 58 may be multi-component sensors, where each sensor may be capable of detecting a pressure wavefield and at least one component of a particle motion that is associated with acoustic signals that are proximate to the sensor. Examples of particle motions include one or more components of a particle displacement, one or more components (inline (x), crossline (y) and vertical (z) components (see axes 59, for example)) of a particle velocity and one or more components of a particle acceleration.

The multi-component seismic sensor may include one or more hydrophones, geophones, particle displacement sensors, particle velocity sensors, accelerometers, pressure gradient sensors, or combinations thereof.

The marine seismic data acquisition system 10 includes one or more seismic sources 40 (two seismic sources 40 being depicted in FIG. 1), such as air guns, vibrators and the like. The seismic sources 40 may be coupled to, or towed by, the survey vessel 20. The seismic sources 40 may operate independently of the survey vessel 20, in that the sources 40 may be coupled to other vessels or buoys, as just a few examples.

As the seismic streamers 30 are towed behind the survey vessel 20, acoustic signals 42 (an acoustic signal 42 being depicted in FIG. 1), often referred to as “shots,” are produced by the seismic sources 40 and are directed down through a water column 44 into strata 62 and 68 beneath a water bottom surface 24. The acoustic signals 42 are reflected from the various subterranean geological formations, such as a formation 65 that is depicted in FIG. 1.

The incident acoustic signals 42 that are generated by the sources 40 produce corresponding reflected acoustic signals, or pressure waves 60, which are sensed by the seismic sensors 58. It is noted that the pressure waves that are received and sensed by the seismic sensors 58 include “up going” pressure waves that propagate to the sensors 58 without reflection from an air-water boundary 31, as well as “down going” pressure waves that are produced by reflections of the pressure waves 60 from an air-water boundary 31.

The seismic sensors 58 generate signals (digital signals, for example), called “traces,” which indicate the acquired measurements of the pressure wavefield and particle motion. It is noted that while the physical wavefield is continuous in space and time, traces are recorded at discrete points in space, which may result in spatial aliasing. The traces are recorded and may be at least partially processed by a signal processing unit 23 that is deployed on the survey vessel 20, in accordance with some embodiments. For example, a particular seismic sensor 58 may provide a trace, which corresponds to a measure of a pressure wavefield measured by a hydrophone; and the sensor 58 may provide (depending the sensor configurations) one or more traces that correspond to one or more components of particle motion.

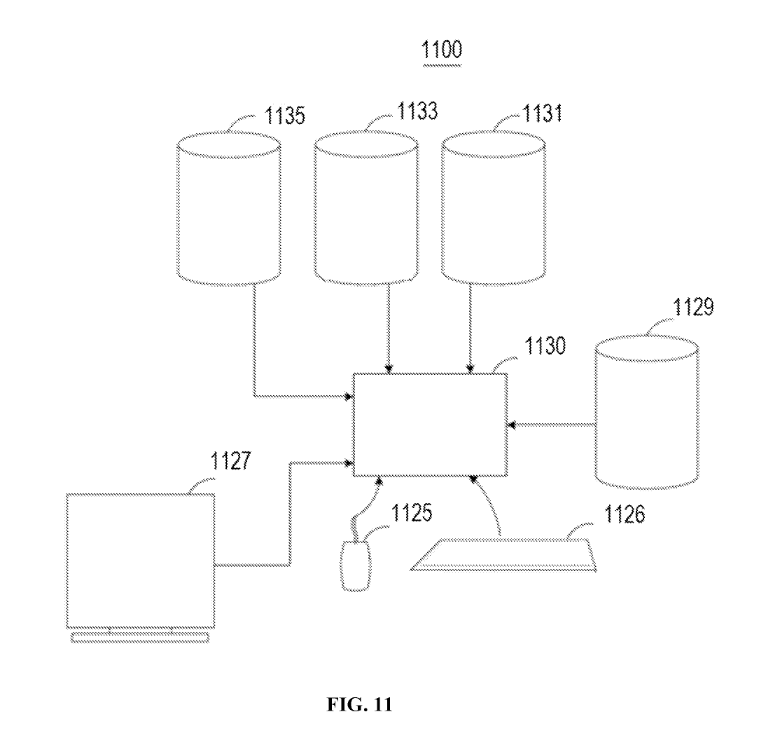

The acquired seismic data is processed to build up an image of a survey area for purposes of identifying subterranean geological formations, such as the geological formation 65. Subsequent analysis of the representation may reveal probable locations of hydrocarbon deposits in subterranean geological formations. Depending on the particular survey design, portions of the analysis of the representation may be performed on the seismic survey vessel 20, by, for example, the signal processing unit 23. In other surveys, the representation may be processed by a seismic data processing system (such as a seismic data processing system in FIG. 11 and is further described below) that may be, for example, located on land or on the vessel 20.

As mentioned earlier, the acquired seismic data needs to be processed or reconditioned before the data can be used to build up an image. If the data is acquired by special methods, e.g. simultaneous source acquisition, the data needs to go through a special process corresponding to the special acquisition method. For data acquired by simultaneous sources, the recorded composite data needs to be separated into different data sets, each corresponding to its own source.

There are many ways to separate composite data of multiple sources into individual data sets, with each corresponding to a single source. For example, the '234 patent application discloses a method using frequency diverse de-aliasing filtering to separate the simultaneous source data. It is found that many other data processing tasks may also be re-formulated into a data separation problem and utilize a method similar to the ones disclosed in the '234 application. Some of these data processing tasks include: deghosting, regularization and interpolation.

In the deghosting process, the ghost signals need to be removed from the acquired data. The ghost signals may be considered as signals from a ghost source, which may be considered as a pseudo simultaneous source that is fired at the same time as a real source at the ‘mirror’ source position.

In data regularization or interpolation, a new set of basis functions with the desired receiver locations are constructed. The desired receiver locations can be more densely and/or regularly located. If necessary, the desired receiver locations can be placed anywhere. With this set of basis functions, the regularized or interpolated data can be computed as described below in more detail.

Using a similar formulation as in the '234 patent application, a seismic survey may be represented in the frequency-space domain with a simple matrix formula: d=Am. The linear operator A represents the physics of a seismic source, the wave propagation associated with the source and the survey geometry; the model called m describes the geology that affects the energy that propagates from the seismic source; and d is the recorded data.

For convenience of notation, assume that there are 2M+1 channels of recorded data, and 2L+1 number of frequencies are used. In embodiments of the present invention, the actual number of channels and frequencies need not to be odd numbers. Defining the sensor position vector x, x=(x,y,z), where x is the coordinate in the in-line direction, y is the coordinate in the cross-line direction and z is the coordinate in the vertical direction.

The frequency-diverse basis function without ghost at slowness p=(pₓ, p_{y}, q) and intercept time, τ₀, can be written as

$$\begin{matrix}g ( p , {τ}_{0} ) = ( \begin{matrix}{g}_{- L} ( {x}_{- M} , p , {τ}_{0} ) \\ ⋮ \\ {g}_{- L} ( {x}_{M} , p , {τ}_{0} ) \\ ⋮ \\ {g}_{0} ( {x}_{- M} , p , {τ}_{0} ) \\ ⋮ \\ {g}_{0} ( {x}_{M} , p , {τ}_{0} ) \\ ⋮ \\ {g}_{L} ( {x}_{- M} , p , {τ}_{0} ) \\ ⋮ \\ {g}_{L} ( {x}_{M} , p , {τ}_{0} )\end{matrix} ) \\ and & ( 1 ) \\ {g}_{l} ( {x}_{i} , p , {τ}_{0} ) = {e}^{- j 2 π {f}_{l} u ( p , {x}_{i} - {x}_{0} , {τ}_{0} )} & ( 1 a )\end{matrix}$$

where pₓ is the in-line slowness, p_{y} is the cross-line slowness and q is the vertical slowness; xᵢ, i=−M, . . . , 0, . . . M, are position vectors of 2M+1 sensors; fₗ, l=−L, . . . , 0, . . . L, are 2L+1 frequencies; τ₀ is the intercept time which represents the arrival time at sensor x₀ of an event with slowness p; u(p, xᵢ−x₀, τ₀) is called the phase function which is a function of slowness p, the relative position between sensor xᵢ and the reference sensor x₀, and its arrival time (τ₀) at sensor x₀. In one example in accordance with some embodiments, the frequencies and the positions are spread around a central frequency or position. The actual frequencies or positions need not to be arranged in a symmetric fashion; however, any arrangement is acceptable for the methods described here.

The phase function u(p, xᵢ−x₀, τ₀) in the basis functions as defined in Equation (1a) can be linear, thereby modeling linear events, and it can be written as

u(p,xᵢ−x₀,τ₀)=pₓ(xᵢ−x₀)+p_{y}(yᵢ−y₀)+q(zᵢ−z₀)+τ₀ (2)

q=\sqrt{1/v_{w}²−pₓ²−p_{y}²} (3)

where v_{w} is the propagation velocity of sound in water.

The phase function u(p, xᵢ−x₀, τ₀) can also be any other type of function that can match a target event curvature, such as hyperbolic, which can be written as

u(p,xᵢ−x₀,τ₀)=\sqrt{pₓ²(xᵢ−x₀)²+p_{y}²(yᵢ−y₀)²+q²(zᵢ−z₀)+τ₀²} (4)

or a more complicated function.

The frequency-diverse basis function with ghost at slowness p for modeling the recorded data can be written as

$$\begin{matrix}{g}^{gh} ( p , {τ}_{0} ) = ( \begin{matrix}{g}_{- L}^{gh} ( {x}_{- M} , p , {τ}_{0} ) \\ ⋮ \\ {g}_{- L}^{gh} ( {x}_{M} , p , {τ}_{0} ) \\ ⋮ \\ {g}_{0}^{gh} ( {x}_{- M} , p , {τ}_{0} ) \\ ⋮ \\ {g}_{0}^{gh} ( {x}_{M} , p , {τ}_{0} ) \\ ⋮ \\ {g}_{L}^{gh} ( {x}_{- M} , p , {τ}_{0} ) \\ ⋮ \\ {g}_{L}^{gh} ( {x}_{M} , p , {τ}_{0} )\end{matrix} ) \\ and & ( 5 ) \\ {g}_{l}^{gh} ( {x}_{i} , p , {τ}_{0} ) = ( 1 + r {e}^{- j 2 π {f}_{l} {qz}_{- M}} ) {e}^{- j 2 π {f}_{l} u ( p , {x}_{- M} - {x}_{0} , {τ}_{0} )} & ( 5 a )\end{matrix}$$

where r is the reflection coefficient at the sea surface.

The 2M+1 sensors and 2L+1 number of frequencies of recorded data, d, can be written in vector form as:

$$d = ( \begin{matrix}d ( {f}_{- L} , {x}_{- M} ) \\ ⋮ \\ d ( {f}_{- L} , {x}_{M} ) \\ ⋮ \\ d ( {f}_{0} , {x}_{- M} ) \\ ⋮ \\ d ( {f}_{0} , {x}_{M} ) \\ ⋮ \\ d ( {f}_{L} , {x}_{- M} ) \\ ⋮ \\ d ( {f}_{L} , {x}_{M} )\end{matrix} ) \qquad ( 6 )$$

In Eq. 5a, the two terms inside the parentheses represent the two reflections: the upgoing wavefield (the desired reflection) and its ghost term (the signal reflected by the sea surface).

In some embodiments, one would next define and discretize the slowness into Nₚ slownesses, from pₘᵢₙ to pₘₐₓ, and define and discretize the intercept time τ₀ into N_{τ}_{₀} times, from τ₀^{min} to τ₀^{max}. The resulting model m is written as

$$m = ( \begin{matrix}m ( {p}_{1} , {τ}_{0}^{1} ) \\ ⋮ \\ m ( {p}_{1} , {τ}_{0}^{{N}_{{τ}_{0}}} ) \\ ⋮ \\ m ( {p}_{{N}_{p}} , {τ}_{0}^{1} ) \\ ⋮ \\ m ( {p}_{{N}_{p}} , {τ}_{0}^{{N}_{{τ}_{0}}} )\end{matrix} ) \qquad ( 7 )$$

Then using the operator A and the model m, the deghosting problem can be written as an optimization problem:

min∥m∥₁ or min∥m∥₀ subject to ∥Am−d∥₂≦ε (8)

where

$$A = ( {g}^{gh} ( {p}_{1} , {τ}_{0}^{1} ) … {g}^{gh} ( {p}_{1} , {τ}_{0}^{{N}_{{τ}_{0}}} ) … {g}^{gh} ( {p}_{{N}_{p}} , {τ}_{0}^{{N}_{{τ}_{0}}} ) ) , \qquad ( 9 )$$

and ε is the noise of the data. The operator A is constructed with basis functions that include ghost reflections.

The l₀-norm or l₁-norm optimization problem as in Eq. 8 can be solved with any optimization method. The solution from Eq. 8 is the model vector m. Using this model vector m, the deghosted data can then be computed by:

$$\begin{matrix}{d}^{deghosted} = Bm \\ where & ( 10 ) \\ {d}^{deghosted} = ( \begin{matrix}{d}^{deghosted} ( {f}_{0} , {x}_{- M} ) \\ ⋮ \\ {d}^{deghosted} ( {f}_{0} , {x}_{M} )\end{matrix} ) \\ and & ( 11 ) \\ B = ( g ( {p}_{1} , {τ}_{0}^{1} ) … g ( {p}_{1} , {τ}_{0}^{{N}_{{τ}_{0}}} ) … g ( {p}_{{N}_{p}} , {τ}_{0}^{{N}_{{τ}_{0}}} ) ) & ( 12 )\end{matrix}$$

where the operator B includes the same basis function as in Eq. 1, which are frequency-diverse basis functions without ghost; m is the model vector, the solution from Eq. 8; and d^{deghosted} is the deghosted data.

In some embodiments, such as those involving group-formed data, a group forming operator can be included in the basis function defined in Eqs. 1 and 5, which can be written as

$$\begin{matrix}{g}_{gf} ( p , {τ}_{0} ) = ( \begin{matrix}grf ( {g}_{- L} ( {x}_{- M} , p , {τ}_{0} ) , {g}_{- L} ( {x}_{- M}^{1} , p , {τ}_{0} ) , … , , {g}_{- L} ( {x}_{- M}^{K} , p , {τ}_{0} ) ) \\ ⋮ \\ grf ( {g}_{- L} ( {x}_{M} , p , {τ}_{0} ) , {g}_{- L} ( {x}_{M}^{1} , p , {τ}_{0} ) , … , , {g}_{- L} ( {x}_{M}^{K} , p , {τ}_{0} ) ) \\ ⋮ \\ grf ( {g}_{0} ( {x}_{- M} , p , {τ}_{0} ) , {g}_{0} ( {x}_{- M}^{1} , p , {τ}_{0} ) , … , , {g}_{0} ( {x}_{- M}^{K} , p , {τ}_{0} ) ) \\ ⋮ \\ grf ( {g}_{0} ( {x}_{M} , p , {τ}_{0} ) , {g}_{0} ( {x}_{M}^{1} , p , {τ}_{0} ) , … , , {g}_{0} ( {x}_{M}^{K} , p , {τ}_{0} ) ) \\ ⋮ \\ grf ( {g}_{L} ( {x}_{- M} , p , {τ}_{0} ) , {g}_{L} ( {x}_{- M}^{1} , p , {τ}_{0} ) , … , , {g}_{L} ( {x}_{- M}^{K} , p , {τ}_{0} ) ) \\ ⋮ \\ grf ( {g}_{L} ( {x}_{M} , p , {τ}_{0} ) , {g}_{L} ( {x}_{M}^{1} , p , {τ}_{0} ) , … , , {g}_{L} ( {x}_{M}^{K} , p , {τ}_{0} ) )\end{matrix} ) \\ and & ( 13 ) \\ {g}_{gf}^{gh} ( p , {τ}_{0} ) = ( \begin{matrix}grf ( {g}_{- L}^{gh} ( {x}_{- M} , p , {τ}_{0} ) , {g}_{- L}^{gh} ( {x}_{- M}^{1} , p , {τ}_{0} ) , … , , {g}_{- L}^{gh} ( {x}_{- M}^{K} , p , {τ}_{0} ) ) \\ ⋮ \\ grf ( {g}_{- L}^{gh} ( {x}_{M} , p , {τ}_{0} ) , {g}_{- L}^{gh} ( {x}_{M}^{1} , p , {τ}_{0} ) , … , , {g}_{- L}^{gh} ( {x}_{M}^{K} , p , {τ}_{0} ) ) \\ ⋮ \\ grf ( {g}_{0}^{gh} ( {x}_{- M} , p , {τ}_{0} ) , {g}_{0}^{gh} ( {x}_{- M}^{1} , p , {τ}_{0} ) , … , , {g}_{0}^{gh} ( {x}_{- M}^{K} , p , {τ}_{0} ) ) \\ ⋮ \\ grf ( {g}_{0}^{gh} ( {x}_{M} , p , {τ}_{0} ) , {g}_{0}^{gh} ( {x}_{M}^{1} , p , {τ}_{0} ) , … , , {g}_{0}^{gh} ( {x}_{M}^{K} , p , {τ}_{0} ) ) \\ ⋮ \\ grf ( {g}_{L}^{gh} ( {x}_{- M} , p , {τ}_{0} ) , {g}_{L}^{gh} ( {x}_{- M}^{1} , p , {τ}_{0} ) , … , , {g}_{L}^{gh} ( {x}_{- M}^{K} , p , {τ}_{0} ) ) \\ ⋮ \\ grf ( {g}_{L}^{gh} ( {x}_{M} , p , {τ}_{0} ) , {g}_{L}^{gh} ( {x}_{M}^{1} , p , {τ}_{0} ) , … , , {g}_{L}^{gh} ( {x}_{M}^{K} , p , {τ}_{0} ) )\end{matrix} ) & ( 14 )\end{matrix}$$

where xᵢ, i=−M, . . . , M is the location of the output of the group forming; sensors at xᵢ^{k}, k=1, . . . , K are sensors used in the group forming at xᵢ; and grf is the operator of group forming.

In embodiments of the present invention, by using the appropriate basis functions, the above methods may be used for processing different types of data, whether the data is acquired by single sensor receivers or group-formed sensors. The group-formed data can be group-formed by analog group forming or digital group forming.

The de-ghosted data obtained in Eq. 10 are data at the actual receiver locations. Those locations may or may not be the desired locations; but most likely, they are not. Assuming the desired locations are y₀, . . . , y_{N-1}, we can form a set of new basis functions, and its operator B becomes:

$$B = ( g ( y , {p}_{1} , {τ}_{0}^{1} ) … g ( y , {p}_{1} , {τ}_{0}^{{N}_{{τ}_{0}}} ) … g ( y , {p}_{{N}_{p}} , {τ}_{0}^{{N}_{{τ}_{0}}} ) ) \qquad ( 15 )$$

From these basis functions and matrix B, using a similar formula as in Eq. 10, we have:

d^{interp}=Bm (16)

where, for frequency f₀,

$${d}^{interp} = ( \begin{matrix}{d}^{interp} ( {f}_{0} , {y}_{0} ) \\ ⋮ \\ {d}^{interp} ( {f}_{0} , {y}_{N - 1} )\end{matrix} ) \qquad ( 17 )$$

This d^{interp} comprises the data at the new locations y₀, . . . , y_{N-1}, which are the desired locations. The deghosted data d^{deghosted} at the actual receiver locations have been transformed into interpolated/regularized data at the desired locations. If the new locations y₀, . . . , y_{N-1} are interpolated locations (i.e. the spatial sampling distance is smaller) compared to the actual receiver locations, then the resulting data set d^{interp} is an interpolated data set. If the new locations y₀, . . . , y_{N-1} are regularized locations (i.e. the spatial sampling distance is uniform but not necessarily smaller) compared to the actual receiver locations, then the resulting data set d^{interp} is a regularized data set. If the new locations y₀, . . . , y_{N-1} are both more dense and regular compared to the actual receiver locations, then the resulting data set d^{interp} is an interpolated and regularized data set. The interpolation and regularization processes may be different processes in many prior art methods, but in the methods described above, the processes themselves may be the same; only the selection of new locations y₀, . . . , y_{N-1} are different.

The resulting data in Eq. 10 (deghosted data) or 16 (interpolated and regularized) are data in the frequency-space domain around one reference frequency f₀. For relevant frequencies in the data, the same method may be used to process these frequencies. Once these frequencies are processed, they are combined in the frequency-space domain. The combined data is transformed back to time-space domain. Such time-space domain data can be used for other purposes, e.g. to build an image of subsurface structure.

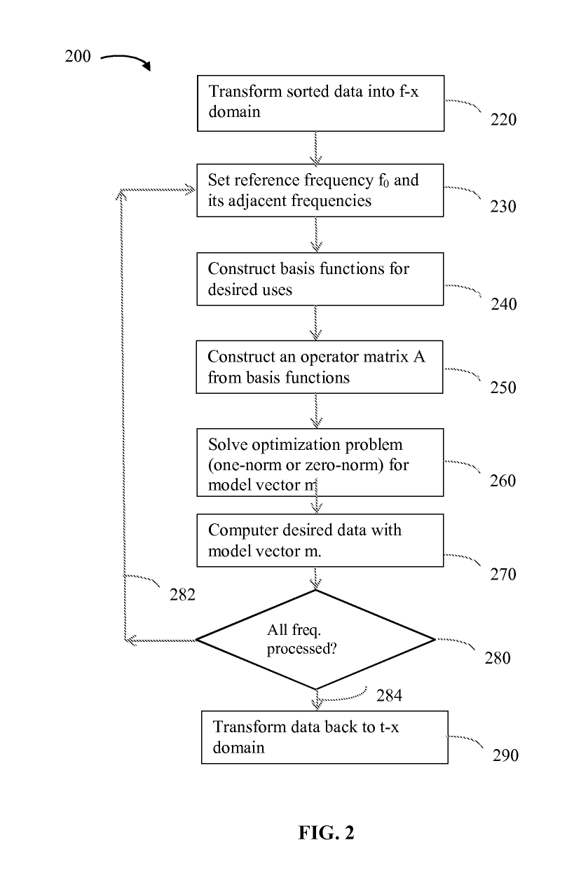

The method described above may be summarized in a flow diagram as shown in FIG. 2. The method 200 may proceed as follows:
transform the data from the time-space domain into the frequency-space domain (220);
set a reference frequency f₀ to a first frequency of the transformed data and select its adjacent frequencies (230) (the total number of different f₀ frequencies is the same total number of frequencies in the transformed data);
compute the multi-frequency basis functions (240) for the desired purposes, for example as described by Eq. 1 and 1a, Eq. 5 and 5a, Eq. 12, 13, 14 and Eq. 15;
construct an operator matrix A from the sets of basis functions (250); for example as in Eq. 9;
solve an optimization problem (260), for example the one-norm or zero-norm problem m for Am−d, for example, as expressed in Eq. 8;
compute the desired data d using the model vector m and the proper set of basis functions (270), for example, as in Eq. 10 for deghosted data d^{deghosted}, or as in Eq. 16 for interpolated or regularized data d^{interp};
check whether relevant frequencies in the data set are processed (280);
   if not, then go to (282), repeat operations from (230) to (270), processing data at another reference frequency f₀ until relevant frequencies in the data have been processed;
   if yes, then go to (284), the data processing in the frequency-space domain is done and combined the processed data in frequency-space domain; and
transform the data in the frequency-space domain back to the time-space domain (290).

Not all operations may be necessary or performed in the sequence as listed above, depending on the dataset conditions, for example, the events in the dataset. Some variations may be used for various purposes. For example, at (230), in selecting data at reference frequency f₀, more data for frequencies above and below reference frequency f₀ may also be selected, or random frequencies in a specified frequency range may be selected. The reference frequency does not need to be in the center of the specified frequency range; it can even be outside the specified frequency range. So, data with the selected number of frequencies is also going through the optimization process, e.g. the one-norm or zero-norm optimization process. Once the model vectors m are determined, data at reference frequency f₀, may be computed from data d. The computed data d^{interp} or d^{deghosted} at reference frequency f₀ may be included with similar data at other frequencies to form the resulting data in the frequency-space domain. In embodiments of the present invention, the reference frequency (output frequency) can be multiple frequencies.

In embodiments of the present invention, it is possible to only select data at the reference frequency f₀ without data at neighboring frequencies at (230). This may reduce the amount of computation in (260), but it may also introduce some computational artifacts.

In embodiments of the present invention, the method 200 may be used to convert a data processing problem into a standard one-norm or zero-norm optimization problem. There are many efficient and cost effective algorithms that can be used to process such problems. In embodiments of the present invention, the cost of the method 200 is mainly the cost of solving the one-norm or zero-norm optimization problem in (260) described above.

The methods described in this application are based on frequency diverse de-aliasing filter, and the methods may be combined with other methods based on other principles of data processing. The datasets may be further processed for various purposes, or the datasets may be used to generate an image of an interior of the Earth.

In some methods as described above, the basis functions are expanded to include multiple frequencies. This is equivalent to filtering the central frequency f₀ by using the frequencies around the central frequency, hence the phrase “frequency diverse” in referring to these methods. The model space may include multiple slownesses between the maximum and minimum slowness pₘₐₓ to pₘᵢₙ and multiple times between a range of intercept time maximum τ₀^{max} and minimum τ₀^{min}.

Similarly, in these methods, the model space m is related to both slowness p and intercept time τ₀ at the reference trace x₀. The multiple intercept time τ₀ included is used to correct the phases of the multiple frequencies in the basis function as defined in Eq. 1a or 5a.

Because of the frequency diversities in the basis functions, these methods can process data regardless of whether the data is aliased or not. This property makes these methods very useful for aliased data, because many other processing methods have difficulties working with aliased data that are results of spatial sampling limitations.

In these methods, the phase function may be selectable based on the targeted events reflected from the subsurface structures, e.g. linear, hyperbolic or a more complex curve may be used to closely conform to the event curvature to avoid data loss during the data separation process, e.g. for events from high-dip structures.

The one-norm or zero-norm optimization problem is constructed for each frequency (also referred to as reference frequency f₀) or multiple frequencies in the acquired data. In embodiments of the present invention, once the data in one frequency or a set of frequencies is processed, the data with another frequency or another set of frequencies may be selected. In embodiments of the present invention, the process is repeated until relevant frequencies in the dataset are filtered. Then, the data may be transformed back to the time-space domain to form the deghosted or interpolated/regularized data in the time-space domain.

In these methods, basis functions are localized in time and frequency or in time, frequency and space.

The methods described above use a similar solver to that used in data separation methods, as such the methods may be combined into one process that can perform all of the relevant functions at once. For example, for processing 3D data acquired by marine simultaneous sources that are aliased along the cross-line direction, the proper sets of basis functions may be constructed. The ghost terms can be included in the basis functions for each simultaneous source. Using these basis functions, one-norm or zero-norm optimization problems are solved to obtain the model vector m. Using the model vector m, and its components m₁ and m₂, the recorded 3D data may be separated into data sets corresponding to individual sources. By setting the reflection coefficient at sea surface to zero and constructing the basis functions at the desired sensor positions, the separated, deghosted data and interpolated/regularized data can be obtained. The only computational intensive step is solving the one-norm optimization. All other steps are straight forward and require minimal computation.

For simplicity, in the above examples, the data may comprise single component pressure data. However, the methods may also be applied to multi-component data with minor modifications. For example, for four-component data that have x, y and z components for the particle velocity and one component for pressure, the data array is simply four times longer than the single component data, which may be represented by:

$$d = ( \begin{matrix}p ( {f}_{- L} , {x}_{- M} ) \\ ⋮ \\ p ( {f}_{L} , {x}_{M} ) \\ ⋮ \\ {v}_{x} ( {f}_{- L} , {x}_{- M} ) \\ ⋮ \\ {v}_{x} ( {f}_{L} , {x}_{M} ) \\ ⋮ \\ {v}_{y} ( {f}_{- L} , {x}_{- M} ) \\ ⋮ \\ {v}_{y} ( {f}_{L} , {x}_{M} ) \\ ⋮ \\ {v}_{z} ( {f}_{- L} , {x}_{- M} ) \\ ⋮ \\ {v}_{z} ( {f}_{L} , {x}_{M} )\end{matrix} ) \qquad ( 18 )$$

where vₓ, v_{y} and v_{z} stand for the three components of particle velocity, and p stands for pressure. This is similar to the array representation of single component data in Eq 6. In embodiments of the present invention, the basis functions may be expanded correspondingly. In embodiments of the present invention, for deghosting, the basis functions may be represented by:

$${g}^{gh} ( p , {τ}_{0} ) = ( \begin{matrix}{g}_{p}^{gh} ( {f}_{- L} , {x}_{- M} , p , {τ}_{0} ) \\ ⋮ \\ {g}_{p}^{gh} ( {f}_{L} , {x}_{M} , p , {τ}_{0} ) \\ ⋮ \\ {g}_{vx}^{gh} ( {f}_{- L} , {x}_{- M} , p , {τ}_{0} ) \\ ⋮ \\ {g}_{vx}^{gh} ( {f}_{L} , {x}_{M} , p , {τ}_{0} ) \\ ⋮ \\ {g}_{vy}^{gh} ( {f}_{- L} , {x}_{- M} , p , {τ}_{0} ) \\ ⋮ \\ {g}_{vy}^{gh} ( {f}_{L} , {x}_{M} , p , {τ}_{0} ) \\ ⋮ \\ {g}_{vz}^{gh} ( {f}_{- L} , {x}_{- M} , p , {τ}_{0} ) \\ ⋮ \\ {g}_{vz}^{gh} ( {f}_{L} , {x}_{M} , p , {τ}_{0} )\end{matrix} ) \qquad ( 19 )$$

where gₚ^{gh}(fᵢ, xⱼ, p, τ₀) are the basis functions for the recorded pressure, gᵥₓ^{gh}(fᵢ, xⱼ, p, τ₀), g_{vy}^{gh}(fᵢ, xⱼ, p, τ₀), and g_{vz}^{gh}(fᵢ, xⱼ, p, τ₀) are the functions for the recorded velocity fields. The resulting optimization can be written in the same way for each component, e.g. as in Eq 8. The optimization can also be written as:

min∥m∥ or min∥m∥₀ subject to ∥W(Am−d)∥₂≦ε (20)

where W are weighting factors for each component, which may be varied depending on many factors of a particular survey.

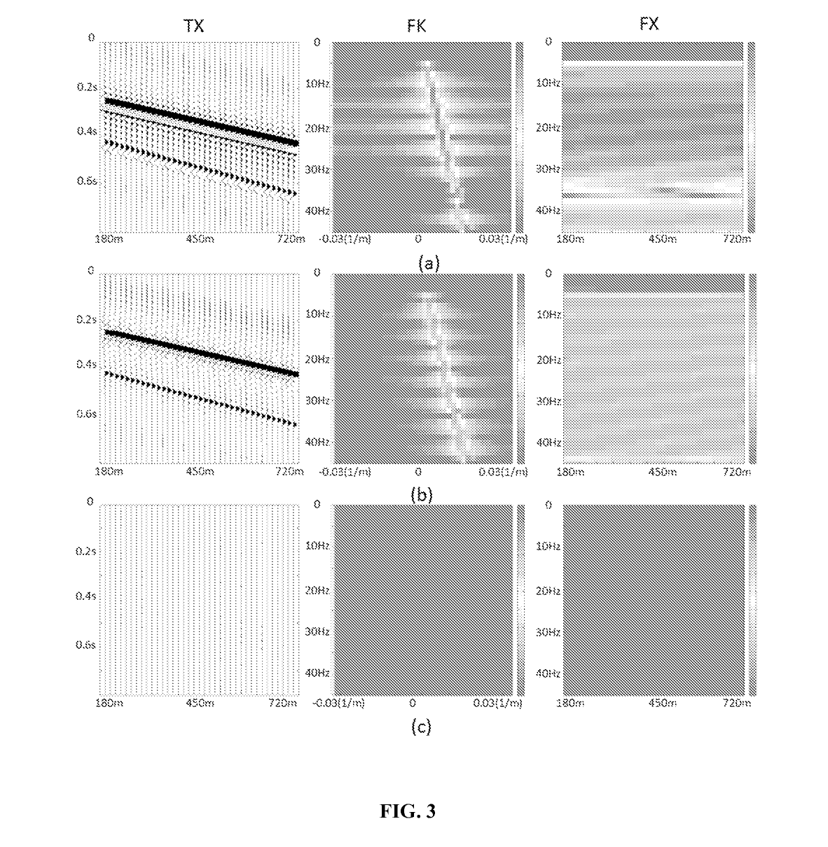

FIGS. 3-10 show several examples to illustrate the effects of the methods described above. FIG. 3 shows a synthetic dataset used to test the deghosting method in accordance with some embodiments described above. The data was recorded using a 900 m flat cable with a sensor interval of 15 m. The data includes two linear un-aliased events; one event is 5 times stronger than the other. Panel (a) shows the raw data, and the notch can be clearly seen from the f-x and f-k plots. Panel (b) shows the deghosted data. It is noticed that the notch of the ghost has been removed from the f-x and f-k plots. Panel (c) shows the deghosting error, which is calculated by subtracting the data without ghost from the deghosted data (Panel b). It can be seen from the data that the error is less than −40 dB (1%).

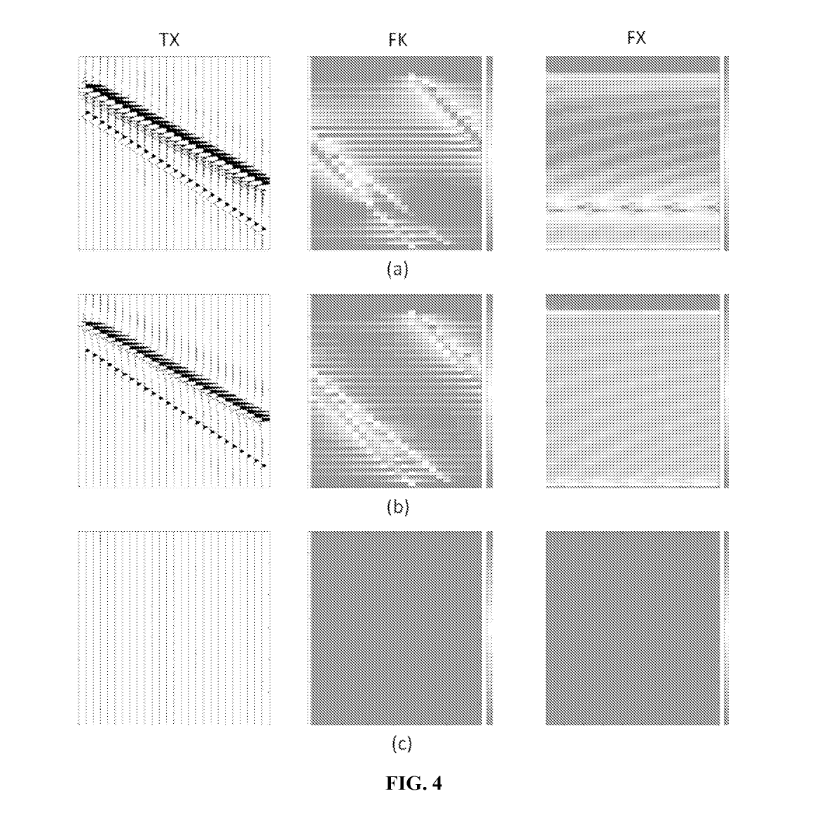

FIG. 4 shows synthetic data recorded using a 900 m flat cable, which is similar to the one in FIG. 3, but with a 75 meter sensor interval. In the data, two events become aliased. Panel (a) shows the raw data; the aliasing and the notch are clearly seen from the f-x and f-k plots. Panel (b) shows the deghosted data. Panel (b) shows that the notch of the ghost has been removed from the f-x and f-k plots. Panel (c) shows the deghosting error, which is calculated by subtracting the data without ghost from the deghosted data (Panel b).

It can be seen that the error is less than −40 dB (1%).

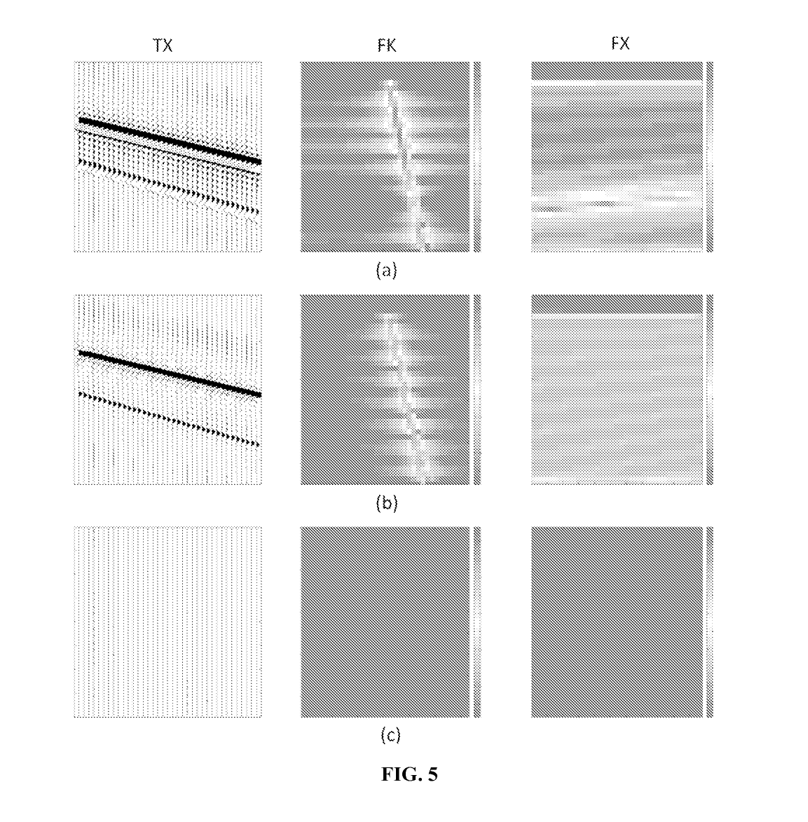

FIG. 5 shows data recorded using a 900 m slant cable with 15 meter sensor interval. The cable has 0.2578° slant angle resulting in a change of depth from a proximal end of the cable at 25 meters to the distal end of the cable at 33 meters. The data includes two linear un-aliased events; one event is 5 times stronger than the other. Panel (a) shows the raw data; the diverse notch is clearly seen from the f-x and f-k plots. Panel (b) shows the deghosted data. Panel (b) shows that the notch of ghost has been removed from the f-x and f-k plots. Panel (c) shows the deghosting error, which is calculated by subtracting the data without ghost from the deghosted data (Panel b). It can be seen that the error is less than −40 dB (1%).

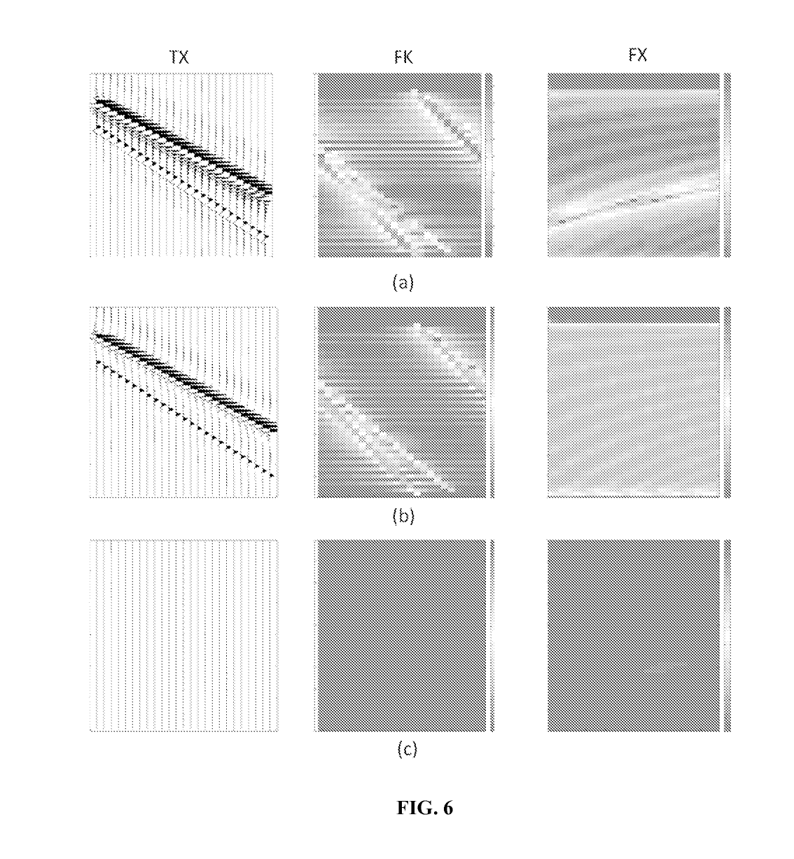

FIG. 6 shows synthetic data recorded using the same 900 m slant cable as in FIG. 5 but with a 75 meter sensor interval. Two events become aliased in this data. Panel (a) shows the raw data; the aliasing and the diverse notch are clearly seen from the f-x and f-k plots. Panel (b) shows the deghosted data. Panel (b) shows that the notch of ghosting has been removed from the f-x and f-k plots. Panel (c) shows the deghosting error, which is calculated by subtracting the data without ghost from the deghosted data (Panel b). It can be seen that the error is less than −40 dB (1%).

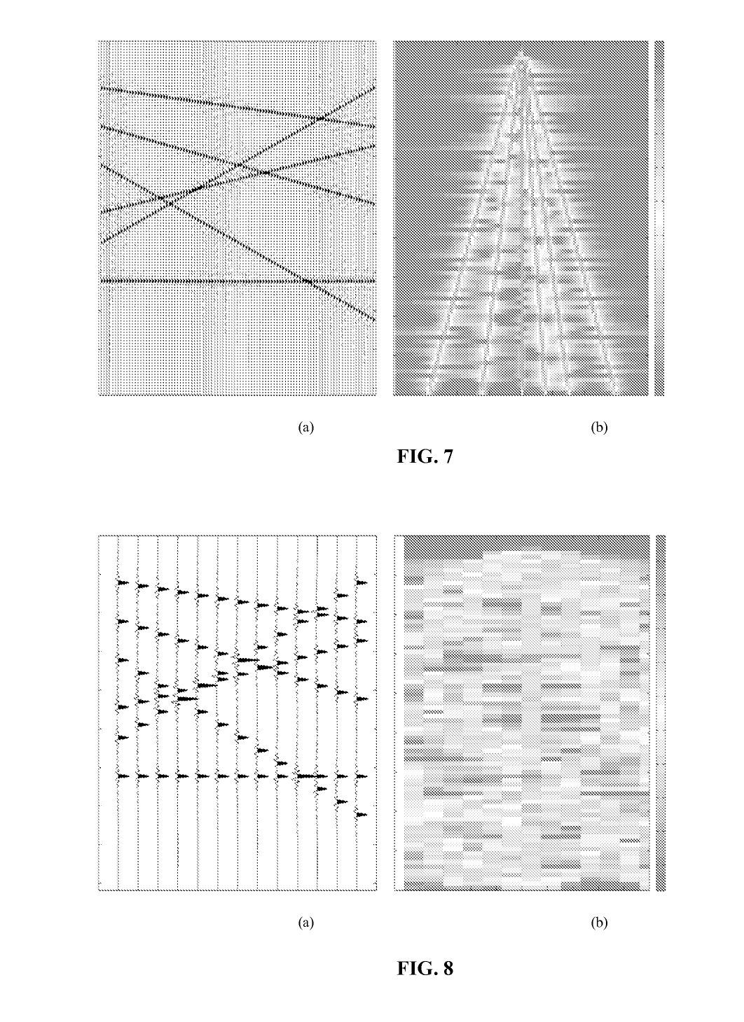

FIG. 7 shows a synthetic dataset used to test interpolation methods described above. Panel (a) is the true data in the t-x domain. The sensor interval is 6.25 m. The frequency range of the data is from 5 Hz to 90 Hz. The data comprise six plane waves with different slownesses. Panel (b) shows the f-k spectrum of the data. From the f-k spectrum, it can be seen that all six events are unaliased.

FIG. 8 shows the data input for an interpolation method. It is a decimation of the true data as shown in FIG. 7. The sensor interval is 50 m. From its f-k spectrum, we can see that five events are aliased, and one event is unaliased.

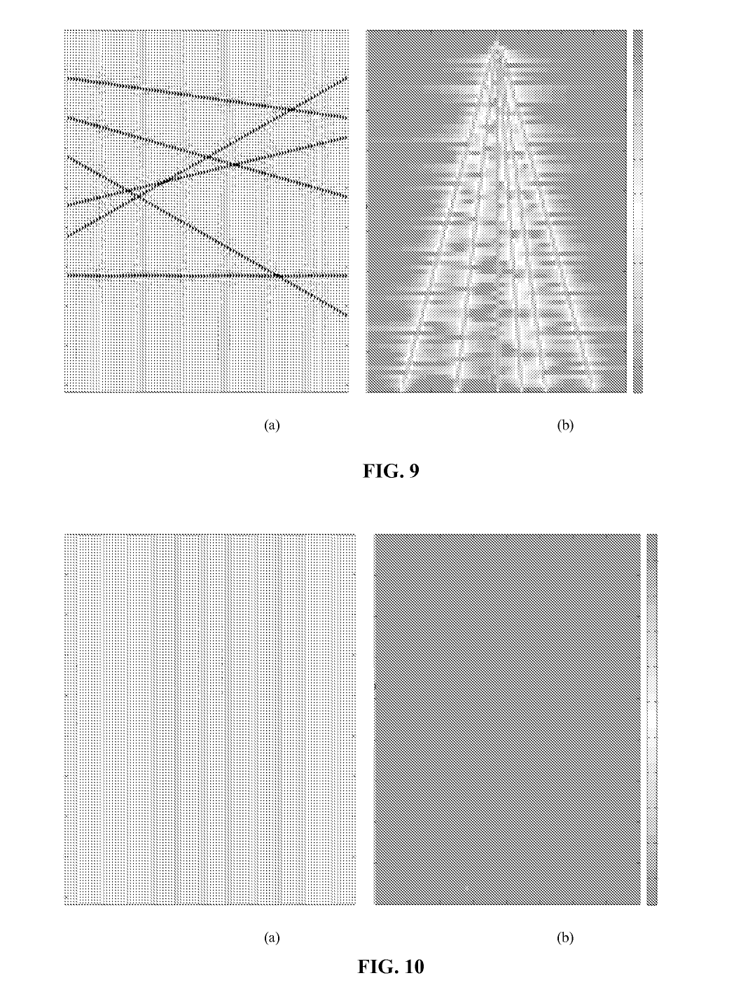

FIG. 9 is the interpolated data obtained using a method described above. The sensor interval of the interpolated data is 6.25 m. The frequency range is from 5 Hz to 90 Hz. Panel (a) shows the interpolated data in the t-x domain, and panel (b) shows the interpolated data in f-k domain. All six events are interpolated extremely well.

FIG. 10 shows the error of the interpolation, which is calculated by subtracting the interpolated data (FIG. 9) from the true data (FIG. 7). From the f-k spectrum of the error (Panel b), the error of the interpolation algorithm is small (less than −40 dB).

As those with skill in the art will understand, one or more of the steps of the methods discussed above may be combined and/or the order of some operations may be changed. Further, some operations in methods may be combined with aspects of other example embodiments disclosed herein, and/or the order of some operations may be changed. The process of measurement, its interpretation, and actions taken by operators may be done in an iterative fashion; this concept is applicable to the methods discussed herein. Finally, portions of methods may be performed by any suitable techniques, including on an automated or semi-automated basis on computing system 1100 in FIG. 11.

Portions of methods described above may be implemented in a computer system 1100, one of which is shown in FIG. 11. The system computer 1130 may be in communication with disk storage devices 1129, 1131, 1133 and 1135, which may be external hard disk storage devices and measurement sensors (not shown). It is contemplated that disk storage devices 1129, 1131, 1133 and 1135 are conventional hard disk drives, and as such, may be implemented by way of a local area network or by remote access. While disk storage devices are illustrated as separate devices, a single disk storage device may be used to store any and all of the program instructions, measurement data, and results as desired.

In one implementation, real-time data from the sensors may be stored in disk storage device 1131. Various non-real-time data from different sources may be stored in disk storage device 1133. The system computer 1130 may retrieve the appropriate data from the disk storage devices 1131 or 1133 to process data according to program instructions that correspond to implementations of various techniques described herein. The program instructions may be written in a computer programming language, such as C++, Java or the like. The program instructions may be stored in a computer-readable medium, such as program disk storage device 1135. Such computer-readable media may include computer storage media. Computer storage media may include volatile and non-volatile media, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the system computer 1130. Combinations of any of the above may also be included within the scope of computer readable media.

In one implementation, the system computer 1130 may present output primarily onto graphics display 1127, or via printer 1128 (not shown). The system computer 1130 may store the results of the methods described above on disk storage 1129, for later use and further analysis. The keyboard 1126 and the pointing device (e.g., a mouse, trackball, or the like) 1125 may be provided with the system computer 1130 to enable interactive operation.

The system computer 1130 may be located on-site, e.g. as part of processing unit 23 on-board a vessel 20 as in FIG. 1 or at a data center remote from the field. The system computer 1130 may be in communication with equipment on site to receive data of various measurements. Such data, after conventional formatting and other initial processing, may be stored by the system computer 1130 as digital data in the disk storage 1131 or 1133 for subsequent retrieval and processing in the manner described above. While FIG. 11 illustrates the disk storage, e.g. 1131 as directly connected to the system computer 1130, it is also contemplated that the disk storage device may be accessible through a local area network or by remote access. Furthermore, while disk storage devices 1129, 1131 are illustrated as separate devices for storing input data and analysis results, the disk storage devices 1129, 1131 may be implemented within a single disk drive (either together with or separately from program disk storage device 1133), or in any other conventional manner as will be fully understood by one of skill in the art having reference to this specification.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for processing seismic data using frequency diverse de-aliasing filtering, the method comprising:
receiving the seismic data from a seismic receiver;
1) transforming the data from a time-space domain into a frequency-space domain (220);
2) setting a reference frequency to a first frequency in the data in the frequency-space domain and selecting a plurality of adjacent frequencies to the reference frequency (230);
3) forming multi-frequency basis functions (240);
4) forming an operator matrix A from the basis functions (250);
5) solving an optimization problem of Am-d to derive model vector m, wherein d is the data (260);
6) computing resulting data from the model vector m and a resulting set of basis functions (270);
7) repeating 2) to 6) until relevant frequencies in the data in the frequency-space domain are used as the reference frequency (282);
8) combining resulting data for all relevant frequencies (284); and
9) transforming the combined resulting data from frequency-space domain into time-space domain (290).

2. The method of claim 1, further comprising:
using the resulting data in time-space domain to generate an image of an interior of the Earth.

3. The method of claim 1, wherein the optimization problem is a one-norm or a zero-norm optimization problem.

4. The method of claim 1, wherein the multi-frequency basis functions comprise a set of ghost-free basis functions, and the resulting data is de-ghosted data.

5. The method of claim 1, wherein the multi-frequency basis functions comprise a set of basis functions having interpolated and regularized receiver positions, and the resulting data is interpolated and regularized data.

6. The method of claim 1, wherein the multi-frequency basis functions comprise a plurality of slownesses.

7. The method of claim 1, wherein the multi-frequency basis functions comprise a plurality of intercept times to for each slowness.

8. The method of claim 1, wherein the multi-frequency basis functions for sources comprise a phase function.

9. The method of claim 8, wherein the phase function comprises a linear function, a hyperbolic function, or a function that has a curvature matching a target event curvature.

10. The method of claim 1, wherein the data comprise single-component data or multi-component data.

11. The method of claim 1, wherein the data comprise single-sensor data or group-formed data.

12. The method of claim 1, wherein the data comprise aliased data.

13. The method of claim 1, wherein the data is acquired by at least one slant stream, or at least one flat streamer, or at least one pair of over/under streamers.

14. The method of claim 1,
wherein the seismic data comprise data acquired using simultaneous source acquisition;
wherein the multi-frequency basis functions comprise a set of basis functions corresponding to each source of the simultaneous sources; a set of basis functions having interpolated and regularized receiver positions, and a set of ghost-free basis functions; and
wherein the resulting data comprise de-ghosted, interpolated and regularized data that are separated and correspond to an individual source of the simultaneous sources.

15. A data processing system for processing seismic data using frequency-diverse de-aliasing filtering, the system comprising:
at least one processor and at least one computer readable storage wherein:
the computer readable storage comprises computer executable instructions, which when executed by the processor, causes the controller to perform a method as in claim 1.
